(19) United States
(12) Patent Application Publication
(10) Pub. No.: US 2010/0204425 A1
(43) Pub. Date: Aug. 12, 2010

(54) PROCESS FOR PREPARING COPOLYMERS OBTAINED BY GRAFT POLYMERIZATION IN SOLUTION AND BASED ON POLYETHERS IN SOLID FORM

(75) Inventors: Murat Mertoglu, Ludwigshafen (DE); Rainer Dobrawa, Mannheim (DE); Kathrin Meyer-Böhm, Feucht (DE); Norbert Güntherberg, Speyer (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/670,680

(22) PCT Filed: Jul. 16, 2008
(86) PCT No.: PCT/EP2008/059299

§ 371 Date: Jan. 26, 2010

(30) Foreign Application Priority Data
Jul. 26, 2007 (EP) 07113228.6

(51) Int. Cl. C08F 26/06

(52) U.S. Cl. 526/264

(57) ABSTRACT

A process for preparing copolymers in solid form, where the copolymers are obtained by free-radical polymerization of a mixture of 30 to 80% by weight of N-vinyllactam, 10 to 50% by weight of vinyl acetate and 10 to 50% by weight of a polyether in the presence of at least one solvent, with the proviso that the total of i), ii) and iii) equals 100% by weight, which process comprises removing the solvent from the polymerization mixture with the aid of an extruder.

The present invention relates to a process for preparing solid copolymers for use as solubilizers for slightly water-soluble substances which are obtained as solutions by polymerizing vinyl acetate and N-vinyllactams in the presence of a polyether. The invention further relates to a process for preparing solid solutions from said copolymers and slightly water-soluble substances.

The corresponding copolymers are, as stated, suitable for use as solubilizers for slightly water-soluble substances.

In the production of homogeneous preparations in particular of bioactive substances, solubilization of hydrophobic, i.e. slightly water-soluble substances, has become of very great practical importance.

Solubilization means making substances which are slightly soluble or insoluble in a particular solvent, especially water, soluble by surface-active compounds, the solubilizers. Such solubilizers are able to convert substances of low or zero solubility in water into clear, or at most opalescent, aqueous solutions without altering the chemical structure of these substances (cf. Römpp Chemie Lexikon, 9th edition, Vol. 5. p. 4203, Thieme Verlag, Stuttgart, 1992).

The produced solubilizates are characterized by the substance of low or zero solubility in water being in the form of a colloidal solution in the aggregates of molecules of the surface-active compounds which form in aqueous solution, such as, for example, hydrophobic domains or micelles. The resulting solutions are stable or metastable single-phase systems which appear optically clear or opalescent.

Solubilizers may for example improve the appearance of cosmetic formulations and of food preparations by making the formulations transparent. In the case of pharmaceutical preparations, there may additionally be an increase in the bioavailability and thus the effect of drugs through the use of solubilizers.

The solubilizers employed for pharmaceutical drugs and cosmetic active substances are mainly surfactants such as ethoxylated castor oil or ethoxylated hydrogenated castor oil, ethoxylated sorbitan fatty acid esters or ethoxylated hydroxystearic acid.

However, the solubilizers described above and employed to date show a number of technical disadvantages when used.

The solubilizing effect of known solubilizers is only low for some slightly soluble drugs such as, for example, clotrimazole.

EP-A 876 819 describes the use of copolymers of at least 60% by weight of N-vinylpyrrolidone and amides or esters with long-chain alkyl groups.

EP-A 948 957 describes the use of copolymers of monoethylenically unsaturated carboxylic acids such as, for example, acrylic acid and hydrophobically modified comonomers such as, for example, N-alkyl- or N,N-dialkylamides of unsaturated carboxylic acids with C₈-C₃₀-alkyl radicals.

DE-A 199 350 63 discloses polyalkylene oxide-containing graft polymers based on vinyllactams and vinyl acetate, and the use thereof as gas hydrate inhibitors.

EP-A 953 347 discloses the use of polyalkylene oxide-containing graft polymers as solubilizers. The graft polymers described therein and composed of vinyl acetate and polyalkylene oxides are frequently not powders but glutinous liquids, which is a technical disadvantage during use.

A further desirable requirement is for solubilizers to be able to form so-called “solid solutions” with slightly soluble substances. The term solid solution refers to a state in which a substance is in the form of a microdispersion or, in the ideal case, a molecular dispersion in a solid matrix, for example a polymer matrix. Such solid solutions result, for example when used in the solid pharmaceutical dosage forms of a slightly soluble active ingredient, in an improved release of the active ingredient. An important requirement is that such solid solutions be stable if stored even for a prolonged period, i.e. that the active ingredient does not crystallize out. Also important is the capacity of the solid solution, in other words the ability to form stable solid solutions with maximum contents of active ingredients.

An important part is played in the formation of solid solutions not only by the fundamental ability of the solubilizers to form solid solutions but also by the hygroscopicity of the solubilizers. Solubilizers which absorb too much water from the ambient air lead to liquefaction of the solid solution and to unwanted crystallization of the active ingredients. A hygroscopicity which is too great may also cause problems in processing to dosage forms.

Many known polymeric solubilizers have the disadvantage that they do not form stable solid solutions. There is moreover room for improvement in relation to solubilization in aqueous systems. Some of the known solubilizers also have disadvantages in relation to processability because of their tendency to tackiness, because they do not represent sufficiently free-flowing powders.

WO 2007/051743 discloses the use of water-soluble or water-dispersible copolymers which are obtained by free-radical polymerization, in particular solution polymerization, of a mixture of
i) 30 to 80% by weight of N-vinyllactam,
ii) 10 to 50% by weight of vinyl acetate and
iii) 10 to 50% by weight of a polyether,
   with the proviso that the total of i), ii) and iii) equals 100% by weight, as solubilizers for applications in pharmaceuticals, cosmetics, food technology, agricultural technology or other industries. It has been possible by the use of such graft polymers to provide solubilizers which do not exhibit the disadvantages described.

Methods known to date for removing the solvent from the polymerization solutions were either freeze drying or spray drying. These processes are not satisfactory from the process engineering and/or economic viewpoint in the present case. In particular in the case of solution polymerization in an organic solvent it is necessary either to replace the organic solvent by water before a spray drying, or to operate with more elaborate safety techniques during spraying from organic solution.

One object of the present invention was an improved process for converting the graft copolymers described above into the solid form from the solution obtained after the polymerization. A further object was to make it possible to incorporate further components, especially slightly water-soluble active substances.

Accordingly, a process for preparing copolymers in solid form has been found, where the copolymers are obtained by free-radical polymerization of a mixture of
i) 30 to 80% by weight of N-vinyllactam,
ii) 10 to 50% by weight of vinyl acetate and
iii) 10 to 50% by weight of a polyether,
   with the proviso that the total of i), ii) and iii) equals 100% by weight, in the presence of at least one solvent, which process comprises removing the solvent from the polymerization mixture with the aid of an extruder.

In one embodiment of the process of the invention, at least one further component, preferably an active substance, is added before or during the removal of the solvent.

In one embodiment of the invention, preferred polymers are obtained from:
i) 30 to 70% by weight of N-vinyllactam
ii) 15 to 35% by weight of vinyl acetate, and
iii) 10 to 35% by weight of a polyether,
   and particularly preferred polymers from:
i) 40 to 60% by weight of N-vinyllactam
ii) 15 to 35% by weight of vinyl acetate
iii) 10 to 30% by weight of a polyether.

Polymers of
i) 50 to 60% by weight of N-vinyllactam
ii) 25 to 35% by weight of vinyl acetate, and
iii) 10 to 20% by weight of a polyether
   are very particularly preferred.

The proviso that the total of the components i), ii) and iii) equals 100% by weight also applies to the preferred and particularly preferred compositions.

N-Vinylcaprolactam or N-vinylpyrrolidone or mixtures thereof are suitable as N-vinyllactam. N-Vinylcaprolactam is preferably used.

Polyethers are used as grafting base. Suitable and preferred polyethers are polyalkylene glycols. The polyalkylene glycols may have molecular weights of from 1000 to 100 000 D [daltons], preferably 1500 to 35 000 D, particularly preferably 1500 to 10 000 D. The molecular weights are determined on the basis of the OH number measured as specified in DIN 53240.

Polyethylene glycols are suitable and particularly preferred polyalkylene glycols. Also suitable are polypropylene glycols, polytetrahydrofurans or polybutylene glycols which are obtained from 2-ethyloxirane or 2,3-dimethyloxirane.

Suitable polyethers are also random or block copolymers of polyalkylene glycols obtained from ethylene oxide, propylene oxide and butylene oxides, such as, for example, polyethylene glycol-polypropylene glycol block copolymers. The block copolymers may be of the AB or ABA type.

Preferred polyalkylene glycols also include those alkylated on one or both terminal OH groups. Suitable alkyl radicals are branched or unbranched C₁- to C₂₂-alkyl radicals, preferably C₁-C₁₈-alkyl radicals, for example methyl, ethyl, n-butyl, isobutyl, pentyl, hexyl, octyl, nonyl, decyl, dodecyl, tridecyl or octadecyl radicals.

General processes for preparing the graft copolymers of the invention are known per se. The preparation takes place by free-radical polymerization, preferably solution polymerization, in nonaqueous organic solvents or in mixed nonaqueous/aqueous solvents.

Suitable nonaqueous organic solvents are, for example, alcohols such as methanol, ethanol, n-propanol and isopropanol, and glycols such as ethylene glycol and glycerol.

Further suitable solvents are esters such as, for example, ethyl acetate, n-propyl acetate, isopropyl acetate, isobutyl acetate or butyl acetate, with preference for ethyl acetate.

The polymerization is preferably carried out at temperatures from 60 to 100° C.

Free-radical initiators are employed to initiate the polymerization. The amounts of initiator or initiator mixtures used, based on monomer employed, are between 0.01 and 10% by weight, preferably between 0.3 and 5% by weight.

Depending on the nature of the solvent used, both organic and inorganic peroxides are suitable, such as sodium persulfate or azo initiators such as azobisisobutyronitrile, azo-bis(2-amidopropane) dihydrochloride or 2,2′-azobis(2-methylbutyronitrile).

Examples of peroxide initiators are dibenzoyl peroxide, diacetyl peroxide, succinyl peroxide, tert-butyl perpivalate, tert-butyl perethylhexanoate, tert-butyl perneodecanoate, tert-butyl permaleate, bis-(tert-butylper)cyclohexane, tert-butylper isopropyl carbonate, tert-butyl peracetate, 2,2-bis(tert-butylper)butane, dicumyl peroxide, di-tert-amyl peroxide, di-tert-butyl peroxide, p-menthane hydroperoxide, pinane hydroperoxide, cumene hydroperoxide, tert-butyl hydroperoxide, hydrogen peroxide and mixtures of said initiators. Said initiators can also be used in combination with redox components such as ascorbic acid.

Particularly suitable initiators are tert-butyl perneodecanoate, tert-butyl perpivalate or tert-butyl perethylhexanoate.

The free-radical polymerization can place if appropriate in the presence of emulsifiers, if appropriate further protective colloids, if appropriate molecular weight regulators, if appropriate buffer systems and if appropriate subsequent pH adjustment using bases or acids.

Suitable molecular weight regulators are sulfhydryl compounds such as alkyl mercaptans, e.g. n-dodecyl mercaptan, tert-dodecyl mercaptan, thioglycolic acid and esters thereof, mercaptoalkanols such as mercaptoethanol. Further suitable regulators are mentioned for example in DE 197 12 247 A1, page 4. The necessary amount of the molecular weight regulators is in the range from 0 to 5% by weight based on the amount of (co)monomers to be polymerized. If regulators are used, the amount employed is in particular in the range from 0.05 to 2% by weight, particularly preferably 0.1 to 1.5% by weight. However, polymerization in the absence of a regulator is very particularly preferred.

It is also possible if appropriate to use emulsifiers, for example ionic or nonionic surfactants whose HLB is normally in the range from 3 to 13. For the definition of HLB, reference is made to the publication by W. C. Griffin, J. Soc. Cosmetic Chem., Volume 5, 249 (1954). The amount of surfactants based on the polymer can be from 0 to 10% by weight, preferably 0 to 5% by weight.

The monomer or the monomer mixture or the emulsion of monomer(s) is introduced together with the initiator, which is generally present in solution, into a stirred reactor at the polymerization temperature (batch process) or if appropriate metered continuously or in a plurality of consecutive stages into the polymerization reactor (feed process). It is usual in the feed process for the reactor have been charged, before the start of the actual polymerization, besides the solvent (in order to make stirring of the reactor possible) also with partial quantities, rarely the total quantity intended for the polymerization, of the starting materials such as emulsifiers, protective colloids, monomers, regulators etc. or partial quantities of the feeds (generally monomer feed or emulsion feed and initiator feed).

The polymerization can be carried out both under atmospheric pressure and under elevated pressure in a closed reactor. Moreover, either polymerization can be carried out under the pressure set up during the reaction, or the pressure can be set up by injecting a gas or evacuating. A further possibility is also to control the pressure by occasional decompression of the reactor into the condenser.

A nonaqueous solvent used for the polymerization can subsequently be removed by steam distillation and replaced by water. In this case, normally the nonaqueous solvent is initially distilled out pure as far as possible, and is subsequently completely replaced by water by passing in steam.

After the polymerization, the polymerization mixtures can be treated by generally known processes for reducing residual monomers. Examples of such processes are further addition of initiator at the end of the polymerization, hydrolysis of vinyllactam monomers by adding acids, treatment of the polymer solution with solid phases such as ion exchangers, feeding in a readily copolymerizing monomer, membrane filtration and further customary methods.

The solids content of polymerization mixtures obtained in this way in the form of polymer dispersions or solutions may be from 10 to 80% by weight. The dispersions or solutions of the polymer are converted according to the invention into the solid form by removing the dispersant or solvent by means of an extruder, preferably in the molten state, and cooling the melt. The process of the invention is preferably carried out with solutions of the active ingredient in an organic solvent. In this connection, solutions with solids contents of 50-80% by weight, particularly preferably 60-70% by weight, are preferably employed.

In one embodiment of the claimed process, the polymer solution or polymer dispersion is introduced into an extruder, where the solvent evaporates while heating and kneading, and a substantially solvent-free melt forms as transport through the extruder continues. In a further preferred variant, this melt is also freed of remaining amounts of solvent and residual monomers and other volatile substances by introducing small amounts of water. The polymer isolated in this way results as melt and can then be cooled and granulated. Since the polymer is generally water-soluble, the usual processes of granulation of thermoplastic melts by cooling with water are less suitable. On the contrary, a so-called hot cut or cooling under air or protective gas takes place for example on a Teflon or chain belt, followed by granulation of the cooled extrudate. In another preferred embodiment, the molten polymer can be further processed in a further step. For example, this melt can be introduced into a suitable mixing device and be provided with active ingredients and additives. Suitable mixing devices are for example a second extruder, kneaders, dynamic and static mixers, also combinations thereof.

A usual process variant is melting of the isolated and solidified polymer described above and mixing with powered or liquid active ingredients or additives. The procedure in this case can be such that all the components are metered singly or as mixture into one or more feed ports of the extruder and are melted together while mixing and then cooled again and granulated. Or else only the polymer is melted and the active ingredient(s) and additive(s) are metered at one or more points through a subsidiary feed (subsidiary conveying screw) into the liquid polymer melt. Liquid additives can also be easily pumped into the extruder by means of a suitable pump (piston pump, diaphragm pump, gear pump, excentric screw pump). The extruder screw should be provided appropriately with suitable mixing elements. Possible examples of suitable mixing elements are conveying and non-conveying kneading blocks, toothed mixing elements, elements with perforated bars, turbomixing elements, knurled mixing elements, toothed blocks etc. In principle, all commercially available mixing elements are suitable, especially those intended for mixing in liquids.

In another preferred embodiment, polymer melts and active substance are mixed together before the granulation.

In a further preferred embodiment of the invention, the dry polymer is obtained in the presence of an active substance and if appropriate further components. It is possible in this case either for the active substance and the further components to be put directly into the solution or dispersion of the polymer or into the molten polymer and for the resulting mixture to be fed to an extruder, or the active substance and the optional further components are introduced separately into the extruder. For example, it is possible for the active substance to be introduced cold as solid, slurry or dispersion into the extruder and the polymer solution to be pumped in, and both to be degassed together, or the polymer solution is introduced, i.e. pumped into the heated extruder, and first a certain proportion of the solvent (for example 50-95%) is evaporated, and then in a later stage the active ingredient is added solid or as slurry and the solvent and suspending agent are evaporated together, or the polymer melt is purified further by stripping with water and only then is the active ingredient added as solid. Or a slurry of the active ingredient in water is added, and this water is simultaneously taken as stripping agent. The construction of the extruder must differ, and the provision of screws and peripherals must differ, depending on the procedure applied. This is explained hereinafter by means of selected examples.

### Methods for Preparing Active Ingredient-Containing Polymers:

The following methods I or II can be used in principle:

| | |
|---|---|
| I | Polymer solution with water or ethyl acetate with active ingredient |
| | dispersed therein in partially degassed polymer melt; polymer |
| | extruded from solution |
| II | Feeding of the active ingredient through a subsidiary feed into the |
| | molten polymer (polymer extruded from solution) |

The extruder types suitable for the process of the invention are in principle the usual ones known to the skilled worker. These normally comprise a housing, a drive unit with transmission, and a process unit which consists of the extruder shaft(s) equipped with the screw elements, a modular construction being presupposed in this case.

The extruder consists of a plurality of sections which are to be assigned in each case to particular process units. Each of these sections consists of one or more barrels (sections) as smallest independent unit and of the relevant screw sections with the screw elements appropriate for the process task.

The process can take place in a single-screw extruder, a twin-screw extruder or in multi-screw extruders, for example a twelve-shaft extruder, but preferably in a twin-screw extruder. A plurality of screws can be designed for co-rotation or counter-rotation, intermeshing or closely intermeshing. The extruder is preferably designed for co-rotation with close intermeshing. The individual barrels are to be heatable. The barrels may also in addition be designed for cooling, for example for cooling with water. The individual extruder sections are preferably heatable and coolable independently of one another, so that different temperature zones can be set up also along the direction of extrusion.

The screws can be constructed of all the elements usual in extrusion. They may, besides conventional conveying elements, also comprise kneading disks, melt flow restrictors or reverse conveying elements. The screw configuration suitable in the individual case depends on the complexity of the objective.

For the present object, the removal of relatively large amounts of solvents, it may be worthwhile to use screws with a particular volume. Normal compounding screws are characterized by the ratio of internal diameter to external diameter and are in the range from 1.1 to 1.8, where 1.4 to 1.8 is preferred for Dᵢ/Dₑ for the present object, particularly preferably 1.45 to 1.8.

The extruder used according to the invention is substantially divided into the following sections:

For degassing the polymer solution, the extruder is divided for example into the following sections:

A first zone with a section which is open at the top and which can serve on the one hand for degassing or gassing with protective gas, or else the feeding in of active ingredient or additives or a neutral polymer to shut off the interior of the extruder toward the outside. The screw is equipped in this region with normal conveying elements and a barrier and melting zone composed of a kneading block and of a reverse-conveying screw element.

This first zone is followed by the feed zone for the polymer solution. This consists of a plurality of sections with apertures at the top which are closed by removable lids. Depending on the objective and degassing behavior of the solution, a lid provided with an injection valve is put onto one of these apertures and the polymer solution is injected through it by means of a pump. The screw has in this region pure conveying elements or else mixing and kneading elements in order to promote surface renewal to favor evaporation. The solvent evaporates thereby and is removed in the following first degassing section through 1 to 2 sections which are for example open at the top, with a slight reduction in pressure (for example atm to 400 mbar). Of course, in principle, sections with lateral apertures are also suitable as long as the product properties permit this (product escape).

In a preferred embodiment, it may also be worthwhile and helpful to provide a degassing aperture behind the injection nozzle in order to improve the operating safety of the process.

The metering of the polymer solution into the extruder takes place by means of pumps through a heatable line. The polymer solution can be metered cold, or be heated to improve flowability, or else be heated to a temperature distinctly above the boiling point of the solvent of the solution so that the solvent evaporates more or less instantaneously on entry into the extruder. The latter procedure is preferred. The vapors removed from the first degassing zone (solvent vapors) are drawn off, condensed and passed on for reuse.

This first degassing zone is followed by a region with closed housing units which, besides conveying screw elements, also have flow-restricting and reverse-conveying elements in order to shut off the extruder chamber from the following second degassing zone. The latter consists of a plurality of sections with one or more degassing apertures which are operated under vacuum. The pressure in this region is normally between 600 and 20 mbar. The screw preferably has conveying elements in this region, but may also comprise kneading or mixing elements.

This second degassing section can if required be followed by further degassing sections of similar design. This may be necessary for example if the temperature and vacuum can increase only slowly because of the degassing properties of the solutions. The last of the degassing sections just mentioned is followed by a section in which the extruder is provided with one or more injection apertures and if appropriate also the possibility for feeding solid or liquid, also molten, additives. It is possible here to incorporate for example additives, but also active ingredients, into the almost completely degassed polymer melt. The screw here has mixing and kneading elements.

The screw elements suitable for this purpose are conveying and non-conveying kneading blocks varying widely in embodiment, likewise combinations of conveying and reverse-conveying screw elements and special mixing elements such as toothed mixing elements, turbomixing elements, toothed blocks and special kneading blocks as are commercially available.

In many cases, the degassing of the polymer solution/polymer dispersion here is better than 99%, but still inadequate. There is thus provision of a stripping agent, for injection, through holes drilled in the housing or in closure plates of open housings, preferably water, in amounts of from 0.1 to 5%, preferably 0.3 to 2%, based on the polymer throughput, through an injection valve and a suitable pump (piston pump, diaphragm pump). The screw elements in this region make vigorous mixing possible. Suitable screw elements are for example toothed mixing elements, narrow conveying and non-conveying kneading disks, melt-mixing elements, turbomixing elements, so-called knurled mixing elements and others, which must be suitably flow restricted in order to ensure a high degree of filling in this region.

This mixing-in zone is followed by at least one last degassing zone in which the stripping agent and the remaining volatile substances are removed. The vacuum in this region should be particularly good and varies in the range from 50 mbar to 2 mbar, which can be achieved for example by means of a vapor pump.

This final degassing zone is followed by discharge from the extruder, for example through a die strip.

It is, however, also possible in principle to incorporate active ingredients and additives into the melt at this point, as long as the extruder still has a feed aperture and appropriate mixing elements on the screw here.

The control of temperature for the extruder is ideally such that the temperature is sufficient for vaporizing the solvent and thermal damage to the polymer and, if appropriate, the additives and active ingredients is precluded. In this case, heat is introduced both via the housing heating, the solution as such and as mechanical energy via the extruder screws. The temperature for the copolymers treated according to the invention is between 100 and 220° C., preferably 110 to 180° C., particularly preferably 120 to 160° C. The ideal temperature range depends on the polymer.

If it is desired to provide the isolated polymer in a second processing step with additives and active ingredients, a far simpler machine is generally sufficient. The polymer is metered either alone or already mixed with the additives or simultaneously with the additives into the feed port of an extruder (cold feed), then conveyed by conveying elements into the melting zone provided with kneading blocks and there plasticized and mixed by intensive kneading. In another preferred variant, the pure polymer is melted and the additive is metered, for example through a subsidiary charger, as powder or solid in another form into the hot melt and there intimately mixed with the polymer stream and likewise homogeneously mixed. It is also possible, and in some cases preferred, to meter the active ingredients and additives cold into the extruder before the melting zone after the polymer has been metered. This procedure avoids certain types of feed problems.

The throughput depends on the polymer-solvent system, the amount of solvent to be removed, the desired degassing efficiency and the type of extruder used and can be ascertained by the skilled worker appropriately by some experiments.

The still plastic mixture is preferably extruded through a die, cooled and pelletized. Suitable for the pelletizing are in principle all the techniques customary for this purpose, such as hot or cold cut.

The extrudate is cut for example with rotating knives or with an air jet and then cooled with air or under protective gas.

It is also possible for the extrudate to be deposited as melt strand on a cooled belt (stainless steel, Teflon, chain belt) and be granulated after solidification.

The extrudate can then be ground if appropriate. The copolymers are obtained as free-flowing water-soluble powders. The particle sizes are preferably adjusted to from 20 to 250 μm.

The polymers have Fikentscher K values in the range from 10 to 60, preferably 15 to 40, measured in a 1% by weight ethanolic solution.

### Applications:

The copolymers obtained according to the invention can be employed in principle in all areas where substances of only low or zero solubility in water are either intended to be employed in aqueous preparations or intended to display their effect in aqueous medium. The copolymers are accordingly used as solubilizers for slightly water-soluble substances, in particular bioactive substances.

The term “slightly water-soluble” includes according to the invention also practically insoluble substances and means that at least 30 to 100 g of water are required per g of substance for the substance to dissolve in water at 20° C. In the case of practically insoluble substances, at least 10,000 g of water are required per g of substance.

In the context of the present invention, slightly water-soluble active substances mean, for example, bioactive substances such as active pharmaceutical ingredients for humans and animals, cosmetic or agrochemical active substances or dietary supplements or dietetic active substances.

Further slightly soluble active substances suitable for solubilization are also colorants such as inorganic or organic pigments.

In the context of this invention, all suitable active substances are also referred to as active ingredients.

The present invention provides in particular amphiphilic compounds for use as solubilizers for pharmaceutical and cosmetic preparations and for food preparations. They have the property of solubilizing slightly soluble active ingredients in the area of pharmacy and cosmetics, slightly soluble dietary supplements, for example vitamins and carotenoids, but also slightly soluble active substances for use in crop protection agents and veterinary medical active ingredients.

### Solubilizers for Cosmetics:

The copolymers can be employed as solubilizers in cosmetic formulations. They are suitable for example as solubilizers for cosmetic oils. They have a good solubilizing capacity for fats and oils such as peanut oil, jojoba oil, coconut oil, almond oil, olive oil, palm oil, castor oil, soybean oil or wheatgerm oil or for essential oils such as dwarf pine oil, lavender oil, rosemary oil, spruce needle oil, pine needle oil, eucalyptus oil, peppermint oil, sage oil, bergamot oil, terpentine oil, melissa oil, juniper oil, lemon oil, anise oil, cardamom oil, camphor oil etc. or for mixtures of these oils.

The polymers can further be used as solubilizers for UV absorbers which are slightly soluble or insoluble in water, such as, for example, 2-hydroxy-4-methoxybenzophenone (Uvinul® M 40, from BASF), 2,2′,4,4′-tetrahydroxy-benzophenone (Uvinul® D 50), 2,2′-dihydroxy-4,4′-dimethoxybenzophenone (Uvinul®D49), 2,4-dihydroxybenzophenone (Uvinul® 400), 2-ethylhexyl 2-cyano-3,3-diphenylacrylate (Uvinul® N 539), 2,4,6-trianilino-p-(carbo-2-ethylhexyl-1-oxy)-1,3,5-triazine (Uvinul® T 150), 3-(4-methoxybenzylidene)camphor (Eusolex® 6300, from Merck), 2-ethylhexyl N,N-dimethyl-4-aminobenzoate (Eusolex® 6007), 3,3,5-trimethylcyclohexyl salicylate, 4-isopropyldibenzoylmethane (Eusolex® 8020), 2-ethylhexyl p-methoxycinnamate and isoamyl p-methoxycinnamate, and mixtures thereof. Also suitable in addition are the camphor derivatives marketed by L′Oréal under the brand names Mexoryl® SX, SL, SO and SW, or Mexoryl XL (drometrizole trisiloxane).

These formulations are water- or water/alcohol-based solubilizates. The solubilizers of the invention are employed in the ratio of from 0.2:1 to 20:1, preferably 1:1 to 15:1, particularly preferably 2:1 to 12:1, to the slightly soluble cosmetic active substance.

The content of solubilizer of the invention in the cosmetic preparation is in the range from 1 to 50% by weight, preferably 3 to 40% by weight, particularly preferably 5 to 30% by weight, depending on the active substance.

It is possible in addition for further auxiliaries to be added to this formulation, for example nonionic, cationic or anionic surfactants such as alkyl polyglycosides, fatty alcohol sulfates, fatty alcohol ether sulfates, alkanesulfonates, fatty alcohol ethoxylates, fatty alcohol phosphates, alkylbetaines, sorbitan esters, POE-sorbitan esters, sugar fatty acid esters, fatty acid polyglycerol esters, fatty acid partial glycerides, fatty acid carboxylates, fatty alcohol sulfosuccinates, fatty acid sarcosinates, fatty acid isethionates, fatty acid taurinates, citric acid esters, silicone copolymers, fatty acid polyglycol esters, fatty acid amides, fatty acid alkanolamides, quaternary ammonium compounds, alkylphenol ethoxylates, fatty amine ethoxylates, cosolvents such as ethylene glycol, propylene glycol, glycerol and others.

Further ingredients which may be added are natural or synthetic compounds, e.g. lanolin derivatives, cholesterol derivatives, isopropyl myristate, isopropyl palmitate, electrolytes, colorants, preservatives, acids (e.g. lactic acid, citric acid).

These formulations are used for example in bath additives such as bath oils, aftershaves, face tonics, hair tonics, eau de cologne, eau de toilette and in sunscreen compositions. A further area of use is the oral care sector, for example in mouthwashes, toothpastes, denture adhesive creams and the like.

The copolymers are also suitable for industrial applications for example for preparations of slightly soluble coloring agents, in toners, preparations of magnetic pigments and the like.

### Description of the Solubilization Method:

The copolymers of the invention can be employed for preparing solubilizates for cosmetic formulations either as 100% pure substance or, preferably, as aqueous solution.

Normally, the solubilizer will be dissolved in water and vigorously mixed with the slightly soluble cosmetic active substance to be used in each case.

However, it is also possible for the solubilizer to be mixed vigorously with the slightly soluble cosmetic active substance to be used in each case and then for demineralized water to be added while stirring continuously.

### Solubilizers for Pharmaceutical Applications:

The copolymers are likewise suitable for use as solubilizer in pharmaceutical preparations of any type, which may comprise one or more drugs which are slightly soluble or insoluble in water, and vitamins and/or carotenoids. Aqueous solutions or solubilizates for oral administration are of particular interest in this connection. Thus, the claimed copolymers are suitable for use in oral dosage forms such as tablets, capsules, powders, solutions. In these they may increase the bioavailability of the slightly soluble drug. Solid solutions of active ingredient and solubilizer are used in particular.

It is possible to employ for parenteral administration besides solubilizers also emulsions, for example fatty emulsions. The claimed copolymers are also suitable for processing a slightly soluble drug for this purpose.

Pharmaceutical formulations of the abovementioned type can be obtained by processing the claimed copolymers with active pharmaceutical ingredients by conventional methods and with use of known and novel active ingredients. The formulation may additionally comprise pharmaceutical excipients and/or diluents. Excipients which are particularly mentioned are cosolvents, stabilizers, preservatives.

The active pharmaceutical ingredients used are insoluble or sparingly soluble in water. According to DAB 9 (German Pharmacopeia), the solubility of active pharmaceutical ingredients is categorized as follows: sparingly soluble (soluble in 30 to 100 parts of solvent); slightly soluble (soluble in 100 to 1000 parts of solvent); practically insoluble (soluble in more than 10 000 parts of solvent). The active ingredients may in this connection come from any range of indications.

Examples which may be mentioned here are benzodiazepines, antihypertensives, vitamins, cytostatics—especially Taxol, anesthetics, neuroleptics, antidepressants, agents having antiviral activity, such as, for example, agents having anti-HIV activity, antibiotics, antimycotics, antidementia drugs, fungicides, chemotherapeutics, urologicals, platelet aggregation inhibitors, sulfonamides, spasmolytics, hormones, immunoglobulins, sera, thyroid therapeutics, psychoactive drugs, antiparkinson agents and other antihyperkinetics, opthalmologicals, neuropathy products, calcium metabolism regulators, muscle relaxants, anesthetics, lipid-lowering agents, hepatotherapeutics, coronary agents, cardiac agents, immunotherapeutics, regulatory peptides and their inhibitors, hypnotics, sedatives, gynecologicals, gout remedies, fibrinolytics, enzyme products and transport proteins, enzyme inhibitors, emetics, blood flow stimulators, diuretics, diagnostic aids, corticoids, cholinergics, biliary therapeutics, anti-asthmatics, bronchodilators, beta-receptor blockers, calcium antagonists, ACE inhibitors, arteriosclerosis remedies, antiinflammatory drugs, anticoagulants, antihypotensives, antihypoglycemics, antihypertensives, antifibrinolytics, antiepileptics, antiemetics, antidotes, antidiabetics, antiarrhythmics, antianemics, antiallergics, anthelmintics, analgesics, analeptics, aldosterone antagonists, slimming agents.

One possible production variant is to dissolve the solubilizer in the aqueous phase, if appropriate with gentle heating, and subsequently to dissolve the active ingredient in the aqueous solubilizer solution. It is likewise possible to dissolve solubilizer and active ingredient simultaneously in the aqueous phase.

It is also possible to use the copolymers of the invention as solubilizer for example by dispersing the active ingredient in the solubilizer, if appropriate with heating, and mixing with water while stirring.

A further possibility is for the solid solubilizers obtained by the process of the invention also to be processed in the melt with the active ingredients in a subsequent extrusion step. It is possible in this way in particular to obtain solid solutions. A further possibility for producing solid solutions is also to prepare solutions of solubilizer and active ingredient in suitable organic solvents and subsequently to remove the solvent by usual processes.

The invention therefore also relates in general to pharmaceutical preparations obtained by the process of the invention which comprise at least one of the copolymers of the invention as solubilizer. Preferred preparations are those which, besides the solubilizer, comprise an active pharmaceutical ingredient which is slightly soluble or insoluble in water, for example from the abovementioned areas of indication.

Particularly preferred pharmaceutical preparations from those mentioned above are formulations which can be administered orally.

The content of solubilizer of the invention of the pharmaceutical preparation is in the range from 1 to 75% by weight, preferably 5 to 60% by weight, particularly preferably 5 to 50% by weight, depending on the active ingredient.

A further particularly preferred embodiment relates to pharmaceutical preparations in which the active ingredients and the solubilizer are present as solid solution, the solvent being removed and the active substance being incorporated in a single process step. In this case, the ratio of solubilizer to active ingredient is preferably from 1:1 to 4:1 by weight, but may be up to 100:1, in particular up to 15:1. What matters is only that, on use in the finished pharmaceutical form, firstly the pharmaceutical form comprises an effective amount of active ingredient, and secondly in the case of oral pharmaceutical forms the forms do not become too large.

### Solubilizers for Food Preparations:

Besides use in cosmetics and pharmacy, the copolymers of the invention are also suitable as solubilizers in the food sector for nutritional substances, auxiliaries or additives which are slightly soluble or insoluble in water, such as, for example, fat-soluble vitamins or carotenoids. Examples which may be mentioned are beverages colored with carotenoids.

### Solubilizers for Crop Protection Preparations:

Use of the copolymers of the invention as solubilizers in agrochemistry may comprise inter alia formulations which comprise pesticides, herbicides, fungicides or insecticides, especially including preparations of crop protection agents employed as formulations for spraying or watering.

The copolymers obtained in this way are distinguished by a particularly good solubilizing effect. They are also able to form so-called solid solutions with slightly soluble substances. Solid solutions refer according to the invention to systems in which no portions of the slightly soluble substance are evidently crystalline on visual inspection. Moreover, no amorphous constituents are evident on visual inspection of the stable solid solutions. The visual inspection takes place with a light microscope with 40× magnification.

The process of the invention allows the polymerization solvent to be removed, and the graft copolymer to be converted into solid form, in a simple manner. The process further allows an active substance to be incorporated simultaneously to result in a solid solution.

The invention is explained in more detail in the following examples.

### Abbreviations Used:

### VCap: N-vinylcaprolactam

### VP: N-vinylpyrrolidone

VAc: vinyl acetate
PEG: polyethylene glycol

### Preparation of the Polymer Solution

The initial charge minus the portion of feed 2 was heated in a stirred apparatus under an N₂ atmosphere to 77° C. When the internal temperature of 77° C. was reached, addition of the feeds was started. Feed 1 was metered in over the course of 5 h, feed 2 was metered in over the course of 2 h and feed 3 was metered in over the course of 5.5 h. After all the feeds had been metered in, the reaction mixture was polymerized for a further 3 h. After the further polymerization, the solution was adjusted to a solids content of 50% by weight.

Initial charge: 25 g of ethyl acetate
104.0 g of PEG 6000,
1.0 g of feed 2
   Feed 1: 240 g of vinyl acetate
   Feed 2: 456 g of vinyl caprolactam
240 g of ethyl acetate
   Feed 3: 10.44 g of tert-butyl perpivalate (75% by weight solution in aliphatic mixture)
67.90 g of ethyl acetate

### Drying of the Polymer Solutions

### Method I:

Polymer solution with water or ethyl acetate with active ingredient dispersed therein

Carbamazepine was employed as active ingredient.

The treatment took place in a Coperion Werner & Pfleiderer ZSK 30 twin-screw extruder. The screw diameter was 30 mm with an l/d ratio of 42. The extruder consisted of a total of 12 sections and 6 spacer plates, corresponding to a total length of 13.5 sections.

Section 1: housing open at the top, screw conveying thread and neutral kneading block shut off on the left,
Section 2: housing open at the side, powder metering options through ZSB, screw only conveying elements
Section 3: housing open at the top, closed with plate and injection nozzle, gear pump connected; housing to be opened at the side to connect an eccentric screw pump. The screw had a conveying configuration in this region, with narrow conveying kneading blocks.
Section 4 and 5: open at the top, with pure conveying screw; degassing zone 1
Section 6 and spacer plate 1 D: closed; screw conveying and neutral kneading blocks, flow-restricted on the left.
Section 7 and 8: open at the top, screw conveying=degassing zone 2
Spacer plate with drilled hole, closed; screw on the left flow-restricted kneading blocks
Section 8: open housing, closed with perforated lid, injection of deionized water, screw: toothed mixing elements.
Section 9: open, degassing
Spacer plate, closed, screw: flow-restricted kneading block
Section 10 and 11: open, degassing by means of vapor pump vacuum
Die head and discharge; screw: conveying elements

### Table:

A 60% by weight polymer solution was employed, composition as described above, pumped in by a gear pump with feed line heated to 140° C. in section 3

| | Ex. No. | | | | |
|---|---|---|---|---|---|
| | 1 | 2 | 3 | 4 | 5 |
| Jacket | 140 | 140 | 140 | 140 | 140 |
| temperature | | | | | |
| Set T (° C.) | | | | | |
| Vacuum in | 800 | 800 | 800 | 800 | 800 |
| section ¾ [mbar] | | | | | |
| Vacuum in | 200 | 200 | 200 | 200 | 200 |
| section 6/7 [mbar] | | | | | |
| Vacuum in | 450 | 450 | 270-300 | 270-300 | 270-300 |
| section 10/11 | | | | | |
| [mbar] | | | | | |
| Vacuum in | 50 | 50 | 50 | | 50 |
| section 9 [mbar] | | | | | |
| Rotation [rpm] | 300 | 300 | 300 | 300 | 300 |
| Torque | 6.4 | 4.0 | 3.7 | 4.3 | 4.3 |
| Motor power [kW] | 3.1 | 1.9 | 1.8 | 2 | 2 |
| Die | ¼ mm | ¼ | ¼ | ¼ | ¼ |
| Solution | 5 | 5 | 5 | 5# | 4# |
| throughput [kg/h] | | | | | |
| Solid throughput [kg/h] | 3 | 3 | 3 | | |
| Deionized water | 0.0183 | 0.0183 | 0.01 | 0.0229 | 0.0183 |
| throughput [kg/h] | | | | | |
| Carbamazepine | — | 0.92 kg/h | — | # 25% | # 25% |
| | | powder | | Carbamazepine | Carbamazepine |
| | | zone 4 | | in polymer | in polymer |
| | | | | solution | solution |

Drying in the presence of an active ingredient: preparation of solid solutions

### Method II:

Active ingredient fed through a separate subsidiary feed into the molten polymer Carbamazepine was employed as active ingredient.

Section 1: housing open at the top, screw conveying thread and neutral kneading block shut off on the left,
Section 2: housing open at the side, powder metering options through ZSB, screw only conveying elements
Section 3: housing open at the top, closed with plate and injection nozzle, gear pump connected; housing to be opened at the side to connect an eccentric screw pump. The screw had a conveying configuration in this region, with narrow conveying kneading blocks.
Section 4 and 5: open at the top, with pure conveying screw; degassing zone 1
Section 6 and spacer plate 1 D; closed; screw conveying and neutral kneading blocks, flow-restricted on the left.
Section 7: open at the top, screw conveying=degassing zone 2
Section 8: closed housing
Spacer plate with drilled hole, closed; screw on the left flow-restricted kneading blocks
Section 9: Open housing, closed with lid, open at the side, subsidiary feed connection option, screw: conveying elements, kneading block.
Spacer plate with water injection, toothed mixing elements screw
Section 10: closed, screw ZSB, flow-restricted
Section 11 and 12: Degassing zone, die head and discharge;
screw: conveying elements

A 60% by weight solution of the polymer+40% by weight additional ethyl acetate was employed, pumped in by a gear pump with feed line heated to 140° C. in section 3

| | Ex. No. | | | | | |
|---|---|---|---|---|---|---|
| | 6 | 7 | 8 | 9 | 10 | 11 |
| Set T/set die T | 140/160 | 140/160 | 140/160 | 140/160 | 140/160 | 140/160 |
| (° C.) | | | | | | |
| Vacuum section | 100 | 100 | 100 | 100 | 100 | 100 |
| ¾ [mbar] | | | | | | |
| Vacuum section 6 | 100 | 100 | 100 | 100 | 100 | 100 |
| [mbar] | | | | | | |
| Vacuum section | 2 | 3 | Ca. 50 | 2 | 50-200 | 30-60 |
| 10/11 [mbar] | | | | | | |
| Rotation [rpm] | 250 | 250 | 250 | 250 | 250 | 250 |
| Torque | 5.0 | 5.4 | 4.2 | 6.5 | 3.8 | 5.0 |
| Motor power [kW] | 1.9 | 2.0 | 1.7 | 2.5 | 1.5 | 1.9 |
| Die diameter | 3/3 mm | ⅔ mm | 3/3 mm | ⅔ mm | 3/3 mm | ⅔ mm |
| Solution | 5000 g/h | 5000 g/h | 4170 g/h | 5000 g/h | 4170 g | 4170 g |
| throughput | | | | | | |
| Deionized water | 30 g/h | 0 | 30 g/h | 30 g/h | 30 g | 30 g |
| throughput | | | | | | |
| Carbamazepine | 1500 g/h | 1500 g/h | 2500 g/h | 1500 g/h | 2000 g | 1330 g/ |
| | | | | | | 670 g |
| Carb. addition | section 2 | section 2 | section 2 | section 9 | section 2 | section 2/ |
| | | | | | | section 9 |

The solid solutions of the active ingredient produced in the polymer were assessed by means of X-ray powder diffractometry (XRD) and DSC.

| | | | | Active | | | |
|---|---|---|---|---|---|---|---|
| | Al content | | Polymer | ingredient | H₂O | | |
| | [% by | | throughput | throughput | throughput | | |
| No. | weight] | Method | [kg/h] | [kg/h] | [kg/h] | XRD | DSC |
| 3 | 33 | I | 5 | 5 | 0.02 | dissolved | dissolved |
| 6 | 33 | II | 5 | 1.5 | 0.03 | dissolved | dissolved |
| 7 | 33 | II | 5 | 1.5 | 0 | dissolved | dissolved |
| 9 | 33 | II | 5 | 1.5 | 0.03 | dissolved | dissolved |
| 11 | 44 | II | 4.17 | 1.33/0.67 | 0.03 | dissolved | dissolved |

1.-5. (canceled)

6. A process for preparing copolymers in solid form, where the copolymers are obtained by free-radical polymerization of a mixture of
(i) 30 to 80% by weight of N-vinyllactam,
(ii) 10 to 50% by weight of vinyl acetate and
(iii) 10 to 50% by weight of a polyether in the presence of at least one solvent,
with the proviso that the total of i), ii) and iii) equals 100% by weight, wherein the process comprises removing the solvent from the polymerization mixture with the aid of an extruder.

7. The process according to claim 6, wherein the polymerization solution is mixed with a slightly water-soluble active substance before removal of the solvent.

8. The process according to claim 6, wherein a slightly water-soluble active substance is introduced into the extruder during removal of the solvents.

9. The process according to claim 6, wherein the copolymers are molten during the removal of the solvent in the extruder.

10. The process according to claim 6, wherein the removal of the solvent takes place at temperatures of from 100 to 220° C.

11. The process according to claim 6, wherein the mixture is
(i) 40 to 60% by weight of N-vinyllactam,
(ii) 15 to 35% by weight of vinyl acetate and
(iii) 10 to 30% by weight of a polyether.

12. The process according to claim 6, wherein the mixture is
(i) 50 to 60% by weight of N-vinyllactam,
(ii) 25 to 35% by weight of vinyl acetate and
(iii) 10 to 20% by weight of a polyether.
